(19) United States
(12) Patent Application Publication
(10) Pub. No.: US 2026/0213214 A1
(43) Pub. Date: Jul. 23, 2026

(54) COMPOSITE CURRENT COLLECTOR

(71) Applicant: GM Global Technology Operations LLC, Detroit, MI (US)

(72) Inventors: Yong Lu, Shanghai (CN); Jingyuan Liu, Shanghai (CN); Meiyuan Wu, Pudong (CN); Haijing Liu, Shanghai (CN)

(21) Appl. No.: 19/035,177

(22) Filed: Jan. 23, 2025

(30) Foreign Application Priority Data
Jan. 20, 2025 (CN) 202510089002.0

(51) Int. Cl. H01M 4/66

(52) U.S. Cl. CPC H01M 4/667; H01M 4/661; H01M 4/663

(57) ABSTRACT

A current collector for a lithium-ion battery includes a polymer substrate, a first layer of functional material positioned onto a top surface of the polymer substrate and a second layer of functional material positioned onto a bottom surface of the polymer substrate, a first metal layer applied onto the first layer of functional material, and a second metal layer applied onto the second layer of functional material, wherein, the first layer of functional material is positioned between and interconnecting the first metal layer and the substrate and the second layer of functional material is positioned between and interconnecting the second metal layer and the polymer substrate.

### INTRODUCTION

The present invention relates generally to a current collector for a lithium-ion battery cell. Lithium-ion batteries are the state-of-the-art power source for most consumer electronic devices, and particularly for electric vehicles. Current collectors are indispensable components bridging lithium-ion batteries and external circuits, greatly influencing the capacity, rate capability and long-term stability of lithium-ion batteries. Current trends are to make current collectors thinner to increase the energy density of the lithium-ion battery.

Thus, while known current collectors achieve their intended purpose, there is a need for a new and improved current collector for a lithium-ion battery that provides a robust compact design.

### SUMMARY

According to several aspects of the present disclosure, a current collector for a lithium-ion battery in accordance with an exemplary embodiment includes a polymer substrate, a first layer of functional material positioned onto a top surface of the polymer substrate and a second layer of functional material positioned onto a bottom surface of the polymer substrate, a first metal layer applied onto the first layer of functional material, and a second metal layer applied onto the second layer of functional material, wherein, the first layer of functional material is positioned between and interconnecting the first metal layer and the substrate and the second layer of functional material is positioned between and interconnecting the second metal layer and the polymer substrate.

According to another aspect, each of the first and second functional layers comprise a matrix of a low melting point binding polymer material, and conductive carbon elements dispersed within the matrix of low melting point binding polymer material.

According to another aspect, the low melting point binding polymer material comprises at least one of: polyvinylidene fluoride (PVDF), polyvinylidene fluoride-hexafluoropropylene (PVDF-HFP), carboxymethyl cellulose (CMC), Poly acrylic acid (PAA) and modified PAA, polyolefins, polyvinylpyrrolidone (PVP), epoxy, phenolic aldehyde, unsaturated polyester, polyurethane, organic silicon, polyimide, and resin.

According to another aspect, each of the first and second functional layers has a thickness that is between about one micro-meter and about two micro-meters.

According to another aspect, the conductive carbon elements dispersed within the matrix of low melting point binding polymer material within each of the first and second functional layers comprises at least one of: one-dimensional carbon elements, two-dimensional carbon elements, and three-dimensional carbon elements.

According to another aspect, the weight of the first and second functional layers comprise between about five percent and about thirty percent of the total weight of the current collector.

According to another aspect, the first functional layer covers between about sixty percent and about eighty percent of the top surface of the polymer substrate providing direct contact between the first metal layer and the polymer substrate over between about twenty percent and about forty percent of the top surface of the polymer substrate, and the second functional layer covers between about sixty percent and about eighty percent of the bottom surface of the polymer substrate providing direct contact between the second metal layer and the polymer substrate over between about twenty percent and about forty percent of the bottom surface of the polymer substrate.

According to another aspect, each of the first and second metal layers comprises one of copper, aluminum, titanium, nickel, silver, or stainless steel.

According to another aspect, each of the first and second metal layers has a thickness that is between about three micro-meters and about six micro-meters.

According to another aspect, the polymer substrate comprises an insulating polymer that is one of polyethylene terephthalate (PET), polypropylene (PP), polyethylene (PE), polyimide (PI), or polylactic acid (PL or PLA).

According to another aspect, the current collector further includes a first carbon layer applied onto the first metal layer and a second carbon layer applied onto the second metal layer.

According to another aspect, the polymer substrate has a thickness that is between about three micro-meters and about eight micro-meters.

According to several aspects of the present disclosure, a method of forming a current collector for a lithium-ion battery includes applying a first layer of functional material onto a top surface of a polymer substrate, applying a second layer of functional material onto a bottom surface of the polymer substrate, applying a first metal layer onto the first layer of functional material, and applying a second metal layer onto the second layer of functional material, wherein, each of the first and second functional layers comprise a matrix of a low melting point binding polymer material, and conductive carbon elements dispersed within the matrix of low melting point binding polymer material, and the first layer of functional material is positioned between and interconnecting the first metal layer and the substrate and the second layer of functional material is positioned between and interconnecting the second metal layer and the polymer substrate.

According to another aspect, the applying the first layer of functional material onto the top surface of the polymer substrate further includes applying, via a slurry cast coating process, the first layer of functional material onto the top surface of the polymer substrate, and the applying the second layer of functional material onto the bottom surface of the polymer substrate further includes applying, via a slurry cast coating process, the second layer of functional material onto the bottom surface of the polymer substrate.

According to another aspect, the applying the first metal layer onto the first layer of functional material further includes applying, via one of physical vapor deposition or direct electro-deposition, the first metal layer onto the first layer of functional material, and the applying the second metal layer onto the second layer of functional material further includes applying, via one of physical vapor deposition or direct electro-deposition, the second metal layer onto the second layer of functional material.

According to another aspect, the method further includes treating the current collector with a hot lamination process and further bonding the first and second functional layers onto the polymer substrate, further bonding the first metal layer to the first functional layer and further bonding the second metal layer to the second functional layer.

According to another aspect, the treating the current collector with a hot lamination process further includes heating the current collector to a temperature that is above a melting point of the low melting point binding polymer material of the first and second functional layers.

According to another aspect, the heating the current collector to a temperature that is above a melting point of the low melting point binding polymer material of the first and second functional layers further includes heating the current collector to a temperature that is between about seventy degrees Celsius and about two-hundred degrees Celsius.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a lithium-ion battery having current collectors in accordance with an exemplary embodiment of the present disclosure;

FIG. 2A is a sectional view of a current collector taken along the line labelled “FIG. 2A-FIG. 2A” in FIG. 1;

FIG. 2B is an enlarged portion of FIG. 2A, as indicated by the circled portion of FIG. 2A labelled “FIG. 2B”;

FIG. 3 is a sectional view of a current collector that includes a carbon layer applied to each of a first metal layer and a second metal layer;

FIG. 4 is a flow chart illustrating a method of forming a current collector in accordance with an exemplary embodiment of the present disclosure;

FIG. 5 is a side view illustrating the application of first and second functional layers via a slurry cast coating process;

FIG. 6 is a side view illustrating the application of first and second metal layers via one of physical vapor deposition or direct electo-deposition; and

FIG. 7 is a side view illustrating treatment of the current collector via a hot lamination process.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances (widths, heights, lengths), comprises plus/minus 10%. In addition, disclosure of ranges includes disclosure of all values and further divided ranges within the entire range, including endpoints and sub-ranges given for the ranges. In addition, disclosure of ranges includes disclosure of all values and further divided ranges within the entire range, including endpoints and sub-ranges given for the ranges.

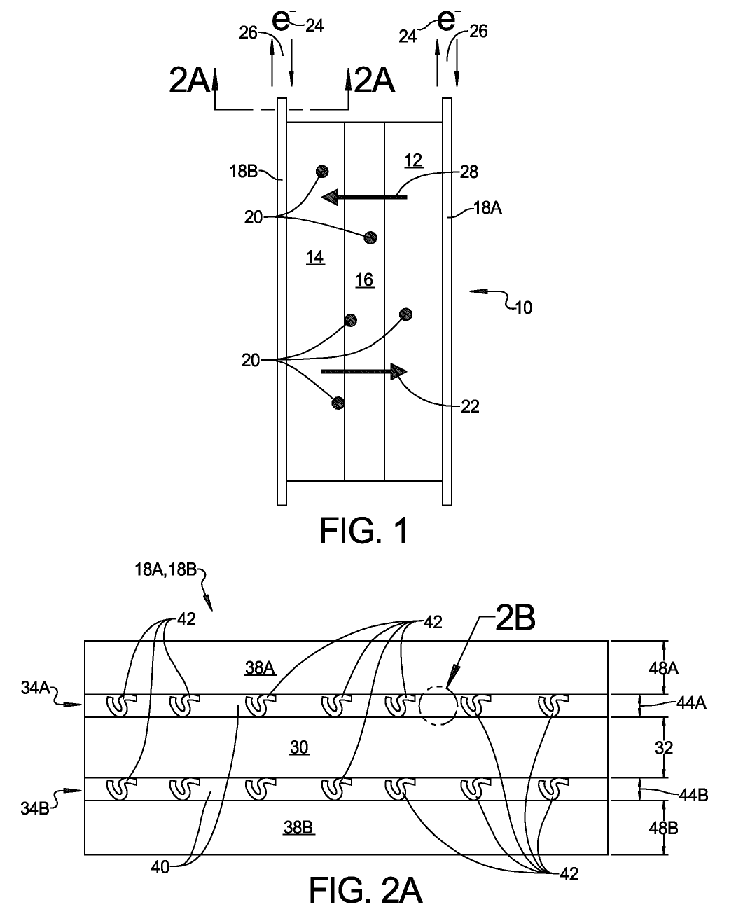

Example embodiments will now be described more fully with reference to the accompanying drawings. In accordance with an exemplary embodiment, FIG. 1 shows a schematic view of a lithium-ion battery 10. Lithium-ion batteries 10 are the state-of-the-art power source for most consumer electronic devices and particularly for electric and hybrid-electric vehicles. A typical lithium-ion battery 10 is composed of a cathode 12, an anode 14, a separator 16, electrolyte and two current collectors 18A, 18B. The current collectors 18A, 18B provide a conduit for the lithium-ion battery 10 to interact with electrical devices and for electrical current to flow into and out from the lithium-ion battery 10. During discharging, when the lithium-ion battery 10 is providing power to a device, lithium ions 20 stored at the anode 14 move across the separator 16 to the cathode 12 via electrolyte, as indicated by arrow 22, generating electrons 24 and forming current flow, as indicated by arrows 26. The process is reversed when the lithium-ion battery 10 is being charged, wherein lithium ions 20 travel from the cathode 12, across the separator 16, and to the anode 14, as indicated by arrow 28.

Current collectors 18A, 18B are indispensable components bridging lithium-ion batteries and external circuits, greatly influencing the capacity, rate capability and long-term stability of lithium-ion batteries. Conventional current collectors using metallic foils made from material like aluminum and copper have been used since the first commercial lithium-ion battery, and, recently, the thickness of these current collectors has decreased in order to increase the energy density. Current collectors are bridging components that collect electrical current generated at the electrodes and connect with external circuits.

Current collectors 18A, 18B can greatly influence the performance of the lithium-ion battery 10. For example, improving the electrical conductivity, reducing contact resistance and increasing the corrosion resistance of current collectors 18A, 18B are beneficial to increase the capacity, rate capability, efficiency and cycle stability of the lithium-ion battery 10. Current collectors 18A, 18B are essentially non-active materials in the lithium-ion battery 10, thus, reducing the metal thickness of the current collectors 18A, 18B can reduce the weight percentage and thus increase the energy density of the lithium-ion battery 10. However, thin current collectors 18A, 18B sacrifice electrical conductivity and heat transfer capability, and, in turn, power density. Further, thin current collectors 18A, 18B are subject to fracturing of the metal conductive layers therein, thus, making them less robust. Therefore, there is a trade-off between power and energy of the lithium-ion battery 10 in the design of the current collectors 18A, 18B. Furthermore, as electrodes are adhered to current collectors 18A, 18B, mechanical integrity is also required in current collectors 18A, 18B in order to maintain a suitable bond to the electrodes during battery cycling, this adhesive strength also contributes to the internal contact resistance of the cell, and requires minimization.

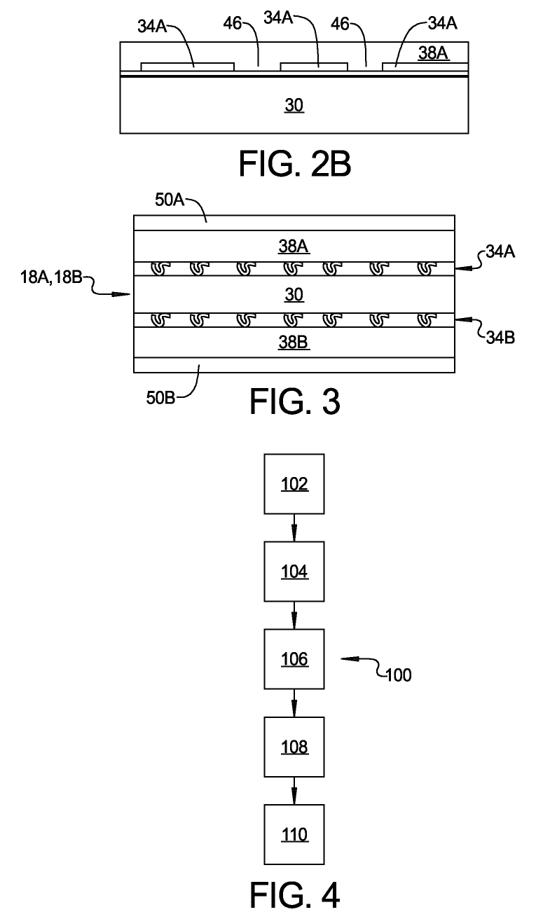

Referring to FIG. 2A, a current collector 18A, 18B for a lithium-ion battery 10 in accordance with aspects of the present disclosure includes a polymer substrate 30. In an exemplary embodiment, the polymer substrate 30 comprises an insulating polymer that is one of polyethylene terephthalate (PET), polypropylene (PP), polyethylene (PE), polyimide (PI), or polylactic acid (PL or PLA). It should be understood by those skilled in the art that the polymer substrate 30 may comprise any material known or developed in the future, that provides mechanical properties that are appropriate for a specific application. A thickness 32 of the polymer substrate 30 is determined based on structural requirements. In general, the thickness of the polymer substrate 30 may be between about two micro-meters and about twenty-five micro-meters. In an exemplary embodiment, the polymer substrate 30 has a thickness 32 that is between about three micro-meters and about eight micro-meters.

The current collector 18A, 18B further includes a first layer of functional material 34A positioned onto a top surface 36A of the polymer substrate 30 and a second layer of functional material 34B positioned onto a bottom surface 36B of the polymer substrate 30. A first metal layer 38A is applied onto the first layer of functional material 34A, and a second metal layer 38B is applied onto the second layer of functional material 34B. The first layer of functional material 34A is positioned between and interconnects the first metal layer 38A and the polymer substrate 30 and the second layer of functional material 34B is positioned between and interconnects the second metal layer 38B and the polymer substrate 30.

The first and second functional layers 34A, 34B provide better bonding to the first and second metal layers 38A, 38B than would be achieved applying the first and second metal layers 38A, 38B directly onto the polymer substrate 30. In addition, the first and second functional layers 34A, 34B provide electrical conductivity, thus, if the first and second metal layers 38A, 38B are damaged in any way, electrical conductivity of the current collector 18A, 18B is maintained, at least in part, by the electrically conductive first and second functional layers 34A, 34B.

In an exemplary embodiment, to provide the bonding and electrical conductivity characteristics discussed above, each of the first and second functional layers 34A, 34B comprises a matrix of a low melting point binding polymer material 40, and conductive carbon elements 42 dispersed within the matrix of low melting point binding polymer material 40. The matrix of low melting point binding polymer material 40 provides good bonding characteristics to both the polymer substrate 30 and to the first and second metal layers 38A, 38B, thus providing improved bonding of the first and second metal layers 38A, 38B to the current collector 18A, 18B over application of the first and second metal layers 38A, 38B directly onto the polymer substrate 30.

In an exemplary embodiment, the low melting point binding polymer material 40 comprises at least one of: polyvinylidene fluoride (PVDF), polyvinylidene fluoride-hexafluoropropylene (PVDF-HFP), carboxymethyl cellulose (CMC), Poly acrylic acid (PAA) and modified PAA, polyolefins, polyvinylpyrrolidone (PVP), epoxy, phenolic aldehyde, unsaturated polyester, polyurethane, organic silicon, polyimide, and resin. A thickness 44A, 44B of each of the first and second functional layers 34A, 34B may be between about half a micro-meter and about four micro-meters. In an exemplary embodiment, the thickness 44A, 44B of each of the first and second functional layers 34A, 34B is between about one micro-meter and about two micro-meters.

In another exemplary embodiment, the conductive carbon elements 42 dispersed within the matrix of low melting point binding polymer material 40 within each of the first and second functional layers 34A, 34B comprises at least one of: one-dimensional carbon elements, two-dimensional carbon elements, and three-dimensional carbon elements. The conductive carbon elements 42 provide electrical conductivity of the first and second functional layers 34A, 34B. One-dimensional carbon elements, such as nano carbon balls, two-dimensional carbon elements, such as carbon plates, and three-dimensional carbon elements, such as carbon tubes or fibers provide structural support within the matrix of low melting point binding polymer material 40 and provide electrical conductivity. The high aspect ratio of the different shaped carbon elements 42 further improves electrical conductivity of the first and second functional layers 34A, 34B.

The first and second functional layers 34A, 34B enable the current collector 18A, 18B to be designed with other layers, such as the polymer substrate 30 and the first and second metal layers 38A, 38B, thinner, thus reducing the overall weight of the current collector 18A, 18B and increasing the power density of the current collector 18A, 18B. In an exemplary embodiment, the weight of the first and second functional layers 34A, 34B comprise between about five percent and about thirty percent of the total weight of the current collector 18A, 18B.

In an exemplary embodiment, the first and second functional layers 34A, 34B do not completely cover the top and bottom surfaces 36A, 36B of the polymer substrate 30. On a microscopic level, the thickness 44A, 44B of each of the first and second functional layers 34A, 34B is between about one micro-meter and about two micro-meters, and is not thick enough to completely fill peaks and valleys within the texture of the top and bottom surfaces 36A, 36B of the polymer substrate 30. Thus, when the first and second metal layers 38A, 38B are applied onto the first and second functional layers 34A, 34B, there will be some direct contact between the first metal layer 38A and the top surface 36A of the polymer substrate 30 and some direct contact between the second metal layer 38B and the bottom surface 36B of the polymer substrate 30. Referring to FIG. 2B, an enlarged view of the current collector 18A, 18B illustrates the first metal layer 38A positioned on the top surface 36A of the polymer substrate 30 with the first functional layer 34A positioned therebetween. There are areas 46, where the first functional layer does not extend between the first metal layer 38A and the top surface 36A of the polymer substrate 30, and where the first metal layer 38A makes direct contact with the top surface 36A of the polymer substrate 30.

In an exemplary embodiment, the first functional layer 34A covers between about sixty percent and about eighty percent of the top surface 36A of the polymer substrate 30 providing direct contact between the first metal layer 38A and the top surface 36A of the polymer substrate 30 over between about twenty percent and about forty percent of the top surface 36A of the polymer substrate 30, and the second functional layer 34B covers between about sixty percent and about eighty percent of the bottom surface 36B of the polymer substrate 30 providing direct contact between the second metal layer 38B and the bottom surface 36B of the polymer substrate 30 over between about twenty percent and about forty percent of the bottom surface 36B of the polymer substrate 30. It should be understood that in various embodiments the first and second functional layers 34A, 34B may cover between about ten percent and about ninety-five percent of the top and bottom surfaces 36A, 36B of the polymer substrate 30, respectively, without departing from the novel features of the present disclosure.

The first and second metal layers 38A, 38B may comprise any highly conductive metal. In an exemplary embodiment, each of the first and second metal layers 38A, 38B comprises one of copper, aluminum, titanium, nickel, silver, or stainless steel. Further, each of the first and second metal layers 38A, 38B has a thickness 48A, 48B that is between about three micro-meters and about six micro-meters, respectively. It should be understood by those skilled in the art that the thickness 48A, 48B of each of the first and second metal layers 38A, 38B may be between about one micro-meter and about twenty micro-meters without departing from the novel features of the present disclosure.

Referring to FIG. 3, in an exemplary embodiment, the current collector 18A, 18B further includes a first carbon layer 50A applied onto the first metal layer 38A and a second carbon layer 50B applied onto the second metal layer 38B. The first and second carbon layers 50A, 50B provide additional structural integrity to the current collector 18A, 18B, improving quality and performance of the current collector 18A, 18B.

Referring to FIG. 4, a method 100 of forming a current collector 18A, 18B for a lithium-ion battery 10 includes, starting at block 102, applying a first layer of functional material 34A onto a top surface 36A of a polymer substrate 30, moving to block 104, applying a second layer of functional material 34B onto a bottom surface 36B of the polymer substrate 30, moving to block 106, applying a first metal layer 38A onto the first layer of functional material 34A, and, moving to block 108, applying a second metal layer 38B onto the second layer of functional material 34B, wherein, each of the first and second functional layers 34A, 34B comprise a matrix of a low melting point binding polymer material 40, and conductive carbon elements 42 dispersed within the matrix of low melting point binding polymer material 40, and the first layer of functional material 34A is positioned between and interconnecting the first metal layer 38A and the polymer substrate 30 and the second layer of functional material 34B is positioned between and interconnecting the second metal layer 38B and the polymer substrate 30.

In an exemplary embodiment, the applying the first layer of functional material 34A onto the top surface 36A of the polymer substrate 30 at block 102 further includes applying, via a slurry cast coating process, the first layer of functional material 34A onto the top surface 36A of the polymer substrate 30, and, the applying the second layer of functional material 34B onto the bottom surface 36B of the polymer substrate 30 at block 104 further includes applying, via a slurry cast coating process, the second layer of functional material 34B onto the bottom surface 36B of the polymer substrate 30.

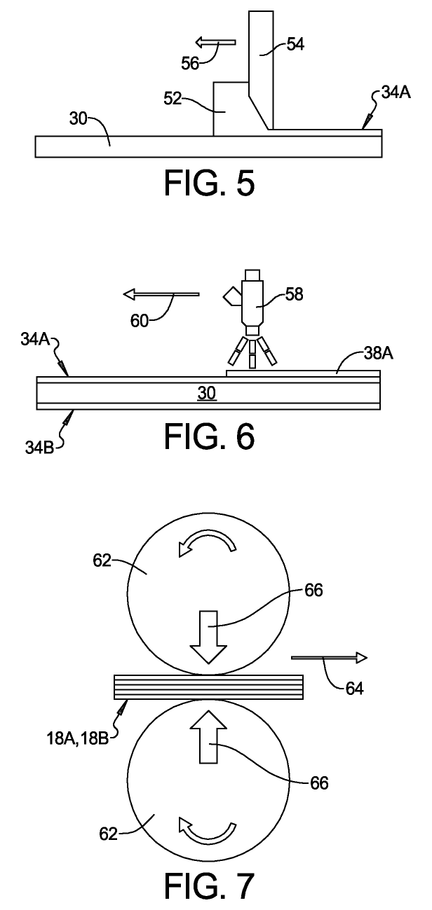

Referring to FIG. 5, a slurry 52 of the functional material in liquid form is pooled onto the polymer substrate 30 and spread across the top or bottom surface 36A, 36B of the polymer substrate with a blade 54 moving across the polymer substrate 30 as indicated by arrow 56. The height of the blade 54 relative to the polymer substrate is determined based on the desired thickness 44A, 44B of the first and second functional layers 34A, 34B. Once spread across the polymer substrate 30, the functional material solidifies and bonds to the polymer substrate, forming the first or second layer of functional material 34A, 34B thereon.

In an exemplary embodiment, the applying the first metal layer 38A onto the first layer of functional material 34A at block 106 further includes applying, via one of physical vapor deposition or direct electro-deposition, the first metal layer 38A onto the first layer of functional material 34A, and the applying the second metal layer 38B onto the second layer of functional material 34B at block 108 further includes applying, via one of physical vapor deposition or direct electro-deposition, the second metal layer 38B onto the second layer of functional material 34B. Referring to FIG. 6, an application head 58 moves over the polymer substrate 30, as indicated by arrow 60, which has the first and second layers of functional material 34A, 34B already applied thereon, and applies the first metal layer 38A onto the first layer of functional material 34A by one of physical vapor deposition or direct electro-deposition.

Physical vapor deposition (PVD) refers to a variety of thin film deposition techniques where a solid material is vaporized in a vacuum environment and deposited on substrates as a pure material or alloy composition coating. PVD transfers the coating material as a single atom or on the molecular level, and thus, provides and extremely pure and high performance coating. Two common PVD Coating processes are “sputtering” and “thermal evaporation”. Sputtering involves the bombardment of the coating material known as the target with a high energy electrical charge causing it to “sputter” off atoms or molecules that are deposited on a substrate. Thermal evaporation involves elevating a coating material to the boiling point in a high vacuum environment causing a vapor stream to rise in the vacuum chamber and then condense on the substrate. Both sputtering and thermal evaporation are fundamentally high vacuum techniques, vaporizing a source material to a plasma of atoms or molecules and depositing them on a substrate. Carried out in a high vacuum chamber with a pressure of approximately 102 to 104 millibar, the process usually takes place between 50 and 500 Degrees C.

Electro-deposition is an electrolytic process of depositing a metal at the cathode from a solution of its electrons. In simpler terms, electro-deposition is an electrolytic procedure in which one metal is deposited over another metal or nonmetal. The electro-deposition process can involve electroplating (depositing metal on any metallic or non-metallic surface in order to protect it from corrosion), electro-metallization (depositing a metal on a conducting base for decorative or protective reasons), or electro-facing (coating metallic surfaces with a harder metal by electro-deposition in order to improve their durability).

In an exemplary embodiment, the method 100 further includes, moving to block 110, treating the current collector 18A, 18B with a hot lamination process and further bonding the first and second functional layers 34A, 34B onto the polymer substrate 30, further bonding the first metal layer 38A to the first functional layer 34A and further bonding the second metal layer 38B to the second functional layer 34B. Referring to FIG. 7, after the first and second functional layers 34A, 34B have been applied to the polymer substrate 30, and after the first and second metal layers 38A, 38B have been applied to the first and second functional layers 34A, 34B, the current collector 18A, 18B is feed between two opposing rollers 62, as indicated by arrow 64, which simultaneously heat the current collector 18A, 18B to a temperature above the melting point of the low melting point binding polymer material 40 and apply pressure, as indicated by arrows 66.

Liquifying the low melting point binding polymer material 40 and applying pressure increases the contact between the low melting point binding polymer material 40 and the substrate 30 and between the low melting point binding polymer material 40 and the first and second metal layers 38A, 38B. Thus, after passing through the rollers 62, the low melting point binding polymer material cools and hardens and forms improved bonds with the substrate 30 and the first and second metal layers 38A, 38B. In an exemplary embodiment, the melting point of the low melting point binding polymer material 40 is between about seventy degrees Celsius and about two-hundred degrees Celsius, and the heating the current collector 18A, 18B to a temperature above the melting point of the low melting point binding polymer material 40 further includes heating the current collector 18A, 18B to a temperature between about seventy degrees Celsius and about two-hundred degrees Celsius.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A current collector for a lithium-ion battery, comprising:
a polymer substrate;
a first layer of functional material positioned onto a top surface of the polymer substrate and a second layer of functional material positioned onto a bottom surface of the polymer substrate;
a first metal layer applied onto the first layer of functional material; and
a second metal layer applied onto the second layer of functional material;
wherein, the first layer of functional material is positioned between and interconnecting the first metal layer and the substrate and the second layer of functional material is positioned between and interconnecting the second metal layer and the polymer substrate.

2. The current collector of claim 1, wherein each of the first and second functional layers comprise:
a matrix of a low melting point binding polymer material; and
conductive carbon elements dispersed within the matrix of low melting point binding polymer material.

3. The current collector of claim 2, wherein the low melting point binding polymer material comprises at least one of: polyvinylidene fluoride (PVDF), polyvinylidene fluoride-hexafluoropropylene (PVDF-HFP), carboxymethyl cellulose (CMC), Poly acrylic acid (PAA) and modified PAA, polyolefins, polyvinylpyrrolidone (PVP), epoxy, phenolic aldehyde, unsaturated polyester, polyurethane, organic silicon, polyimide, and resin.

4. The current collector of claim 2, wherein each of the first and second functional layers has a thickness that is between about one micro-meter and about two micro-meters.

5. The current collector of claim 2, wherein the conductive carbon elements dispersed within the matrix of low melting point binding polymer material within each of the first and second functional layers comprises at least one of: one-dimensional carbon elements, two-dimensional carbon elements, and three-dimensional carbon elements.

6. The current collector of claim 2, wherein the weight of the first and second functional layers comprise between about five percent and about thirty percent of the total weight of the current collector.

7. The current collector of claim 2, wherein:
the first functional layer covers between about sixty percent and about eighty percent of the top surface of the polymer substrate providing direct contact between the first metal layer and the polymer substrate over between about twenty percent and about forty percent of the top surface of the polymer substrate; and
the second functional layer covers between about sixty percent and about eighty percent of the bottom surface of the polymer substrate providing direct contact between the second metal layer and the polymer substrate over between about twenty percent and about forty percent of the bottom surface of the polymer substrate.

8. The current collector of claim 2, wherein each of the first and second metal layers comprises one of copper, aluminum, titanium, nickel, silver, or stainless steel.

9. The current collector of claim 2, wherein each of the first and second metal layers has a thickness that is between about three micro-meters and about six micro-meters.

10. The current collector of claim 2, wherein the polymer substrate comprises an insulating polymer that is one of polyethylene terephthalate (PET), polypropylene (PP), polyethylene (PE), polyimide (PI), or polylactic acid (PL or PLA).

11. The current collector of claim 2, further including a first carbon layer applied onto the first metal layer and a second carbon layer applied onto the second metal layer.

12. The current collector of claim 2, wherein the polymer substrate has a thickness that is between about three micro-meters and about eight micro-meters.

13. A method of forming a current collector for a lithium-ion battery comprising:
applying a first layer of functional material onto a top surface of a polymer substrate;
applying a second layer of functional material onto a bottom surface of the polymer substrate;
applying a first metal layer onto the first layer of functional material; and
applying a second metal layer onto the second layer of functional material;
wherein, each of the first and second functional layers comprise a matrix of a low melting point binding polymer material, and conductive carbon elements dispersed within the matrix of low melting point binding polymer material; and
the first layer of functional material is positioned between and interconnecting the first metal layer and the substrate and the second layer of functional material is positioned between and interconnecting the second metal layer and the polymer substrate.

14. The method of claim 13, wherein:
the applying the first layer of functional material onto the top surface of the polymer substrate further includes applying, via a slurry cast coating process, the first layer of functional material onto the top surface of the polymer substrate; and
the applying the second layer of functional material onto the bottom surface of the polymer substrate further includes applying, via a slurry cast coating process, the second layer of functional material onto the bottom surface of the polymer substrate.

15. The method of claim 14, wherein:
the applying the first metal layer onto the first layer of functional material further includes applying, via one of physical vapor deposition or direct electro-deposition, the first metal layer onto the first layer of functional material; and
the applying the second metal layer onto the second layer of functional material further includes applying, via one of physical vapor deposition or direct electro-deposition, the second metal layer onto the second layer of functional material.

16. The method of claim 15, further including treating the current collector with a hot lamination process and further bonding the first and second functional layers onto the polymer substrate, further bonding the first metal layer to the first functional layer and further bonding the second metal layer to the second functional layer.

17. The method of claim 16, wherein the treating the current collector with a hot lamination process further includes heating the current collector to a temperature that is above a melting point of the low melting point binding polymer material of the first and second functional layers.

18. The method of claim 17 wherein the heating the current collector to a temperature that is above a melting point of the low melting point binding polymer material of the first and second functional layers further includes heating the current collector to a temperature that is between about seventy degrees Celsius and about two-hundred degrees Celsius.

19. A lithium-ion battery having at least one current collector, the at least one current collector comprising:
a polymer substrate having a thickness that is between about three micro-meters and about eight micro-meters and comprising an insulating polymer that is one of polyethylene terephthalate (PET), polypropylene (PP), polyethylene (PE), polyimide (PI), or polylactic acid (PL or PLA);
a first layer of functional material positioned onto a top surface of the polymer substrate and a second layer of functional material positioned onto a bottom surface of the polymer substrate, each of the first and second functional layers having a thickness that is between about one micro-meter and about two micro-meters and comprising:
a matrix of a low melting point binding polymer material comprising at least one of polyvinylidene fluoride (PVDF), polyvinylidene fluoride-hexafluoropropylene (PVDF-HFP), carboxymethyl cellulose (CMC), Poly acrylic acid (PAA) and modified PAA, polyolefins, polyvinylpyrrolidone (PVP), epoxy, phenolic aldehyde, unsaturated polyester, polyurethane, organic silicon, polyimide, and resin; and
conductive carbon elements dispersed within the matrix of low melting point binding polymer material and comprising at least one of: one-dimensional carbon elements, two-dimensional carbon elements, and three-dimensional carbon elements;
a first metal layer applied onto the first layer of functional material having a thickness that is between about three micro-meters and about six micro-meters and comprising one of copper, aluminum, titanium, nickel, silver, or stainless steel; and
a second metal layer applied onto the second layer of functional material having a thickness that is between about three micro-meters and about six micro-meters and comprising one of copper, aluminum, titanium, nickel, silver, or stainless steel;
wherein, the first layer of functional material is positioned between and interconnecting the first metal layer and the substrate and the second layer of functional material is positioned between and interconnecting the second metal layer and the polymer substrate.

20. The lithium-ion battery of claim 19 wherein:
the weight of the first and second functional layers comprise between about five percent and about thirty percent of the total weight of the current collector;
the first functional layer covers between about sixty percent and about eighty percent of the top surface of the polymer substrate providing direct contact between the first metal layer and the polymer substrate over between about twenty percent and about forty percent of the top surface of the polymer substrate; and
the second functional layer covers between about sixty percent and about eighty percent of the bottom surface of the polymer substrate providing direct contact between the second metal layer and the polymer substrate over between about twenty percent and about forty percent of the bottom surface of the polymer substrate.
